(19) United States
(12) Patent Application Publication
(10) Pub. No.: US 2013/0224716 A1
(43) Pub. Date: Aug. 29, 2013

(54) CLOUD-BASED MULTIMEDIA TEACHING SYSTEM, DEVELOPMENT METHOD AND INTERACTION METHOD THEREOF

(71) Applicants: Jerry Chih-Yuan SUN, Hsinchu City (TW); John P. Walsh, Los Angeles, CA (US); Greg Misiaszek, Los Angeles, CA (US)

(72) Inventors: Jerry Chih-Yuan SUN, Hsinchu City (TW); John P. Walsh, Los Angeles, CA (US); Greg Misiaszek, Los Angeles, CA (US)

(21) Appl. No.: 13/601,856

(22) Filed: Aug. 31, 2012

(30) Foreign Application Priority Data
Feb. 24, 2012 (TW) 101106430

(51) Int. Cl. G09B 5/00

(52) U.S. Cl. 434/350

(57) ABSTRACT

The present invention discloses a cloud-based multimedia teaching system, a development method and an interaction method thereof. In the present invention, a teacher produces a course in the Abode Flash format and uploads it from a client computer to a multimedia teaching system via the cloud; the multimedia teaching system communicates with a back-end server via a server framework in the Flash Remoting technology and establishes the course in the back-end server; the user interface of the multimedia teaching system contains a plurality of buttons linked to the courses. When a user clicks on a button of the user interface to select a course, the multimedia teaching system retrieves related data of the course from the back-end server via the server framework in the Flash Remoting technology and presents the data on the user interface thereof.

### BACKGROUND OF THE INVENTION

1. Field of the Invention

The present invention relates to a multimedia teaching website, particularly to a cloud-based multimedia teaching system, a development method and an interaction method thereof.

2. Description of the Related Art

Online courses are emerging with advance of network technology and arrival of digital age. Online courses may be realized with a far-end teaching systems or an online teaching system. In the far-end teaching system, the AV (Audio-Video) data of a course is transmitted to the computer of the learner side in realtime via an Internet conference technology, whereby learners not in the classroom can also attend the course synchronously. In the online teaching system, learners can access the teaching material and learn it via the Internet.

In the current online teaching system, teaching material is transmitted to the system platform in the form of text or AV files, and the learners log in the platform to listen and/or watch the teaching material. However, text or AV teaching material is less vivid and therefore hard to motivate users to learn the material. Further, the current online teaching system, such as the Blackboard system, plays the PowerPoint files or AV files of teaching material in a streaming way. Thus, a learner cannot directly select the lesson interesting him but can only receive the course in a sequence of Lesson 1, Lesson 2, . . . . Besides, some online teaching systems do not store teaching material in databases. Thus, the teacher has to download the complete contents from the website when he intends to modify the contents and then upload the complete modified contents to the website after content modification. In such a case, the teacher not only has to install the online teaching system in his computer but also has to preserve a storage space sufficient to download the contents. If the size of contents is very great, download and upload must take a very long time and may even cause errors. Therefore, the teacher may be beset or even exhausted by only modifying contents.

Accordingly, the present invention proposes a cloud-based multimedia teaching system, a development method and an interaction method thereof to overcome the abovementioned problems.

### SUMMARY OF THE INVENTION

The primary objective of the present invention is to provide a cloud-based multimedia teaching system, a development method and an interaction method thereof, wherein the back-end server intercommunicates with clients using the Flash Remoting technology, and wherein the courses are presented on the user interface in the Adobe Flash format, whereby movies and animations can be added to the teaching contents to increase vividness and abundance of the courses.

Another objective of the present invention is to provide a cloud-based multimedia teaching system, a development method and an interaction method thereof, wherein the server framework is realized with the Adobe ColdFusion functions to access the data of the back-end server.

Yet another objective of the present invention is to provide a cloud-based multimedia teaching system and an interaction method thereof, wherein all the operations of users are stored in the back-end server, including the login time, the staying time of each webpage of a course, the clicks, the interval between two adjacent clicks, compulsory logouts, progress of learning, evaluation of achievement, etc, whereby the teachers and users can review the learning activities.

A further objective of the present invention is to provide a cloud-based multimedia teaching system and an interaction method thereof, wherein users can arbitrarily select lessons meeting their requirements, whereby is increased flexibility of learning and adaptability of courses.

To realize the abovementioned objectives, the present invention proposes an interaction method of a cloud-based multimedia teaching system, which comprises steps: a client uploading at least one course to a multimedia teaching system via the cloud; the multimedia teaching system communicating with a back-end server in the Flashing Remoting technology to establish the course in the back-end server; a user clicking on a button of a user interface of the multimedia teaching system to retrieve related data of the course from the back-end server via a server framework in the Flashing Remoting technology and present the data on the user interface of the multimedia teaching system.

The present invention also proposes a development method of a cloud-based multimedia teaching system, which comprises steps: selecting a layout of a user interface containing a plurality of buttons; a client uploading at least one course to a back-end server, and establishing a plurality of links between the courses and the buttons; and generating a database for storing the links.

The present invention also proposes a cloud-based multimedia teaching system, which comprises a user interface containing a plurality of buttons respectively denoting a plurality of courses; at least one back-end server storing data of a plurality of courses and data of a plurality of users; a database built in the back-end server or independent from the back-end server, and storing links between the buttons and the courses; and a server framework connected with clients and the back-end server, communicating with and retrieving data from the back-end server in the Flash Remoting technology.

Below, embodiments are described in detail to make easily understood the objectives, technical contents, characteristics and accomplishments of the present invention.

### BRIEF DESCRIPTION OF THE DRAWINGS

FIG. 1A and FIG. 1B are block diagrams respectively showing cloud-based multimedia teaching systems according to two embodiments of the present invention;

FIG. 2 schematically a layout of a user interface of a multimedia teaching system according to one embodiment of the present invention;

FIG. 3 shows a flowchart of a development method for a cloud-based multimedia teaching system according to one embodiment of the present invention; and

FIG. 4 shows a flowchart of an interaction method for a cloud-based multimedia teaching system according to one embodiment of the present invention.

### DETAILED DESCRIPTION OF THE INVENTION

The present invention discloses a cloud-based multimedia teaching system, a development method and an interaction method thereof. Firstly is built a multimedia teaching system on the Internet. A teacher can login the multimedia teaching system from any computer to edit the interface of the course and upload the data of the course to a back-end server of the multimedia teaching system, whereby are simplified the operations of producing the webpages of the course. A user can arbitrarily select courses from the multimedia teaching system according to his interest or his learning schedule. The multimedia teaching system records the buttons the user clicks on during online learning, whereby the teacher and the user can effectively evaluate the progress and achievement of learning.

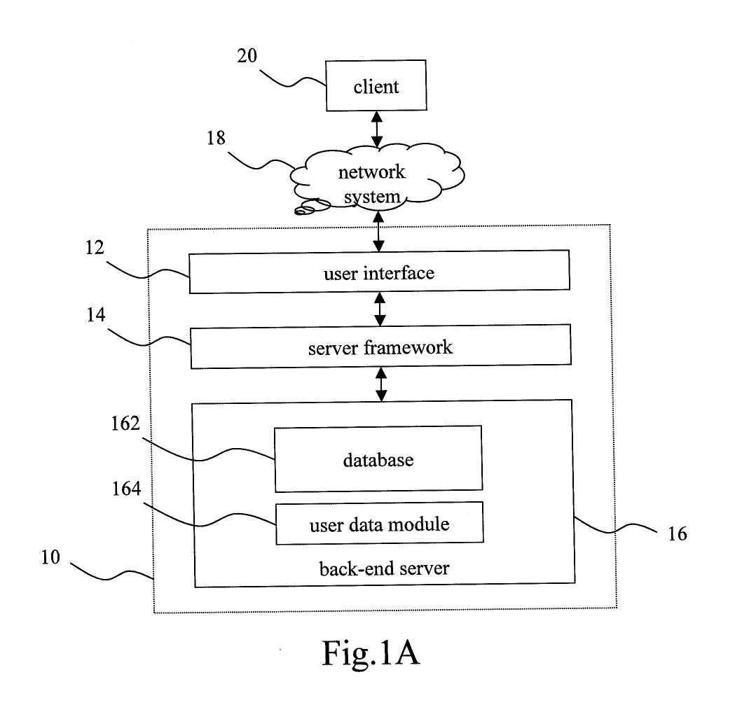

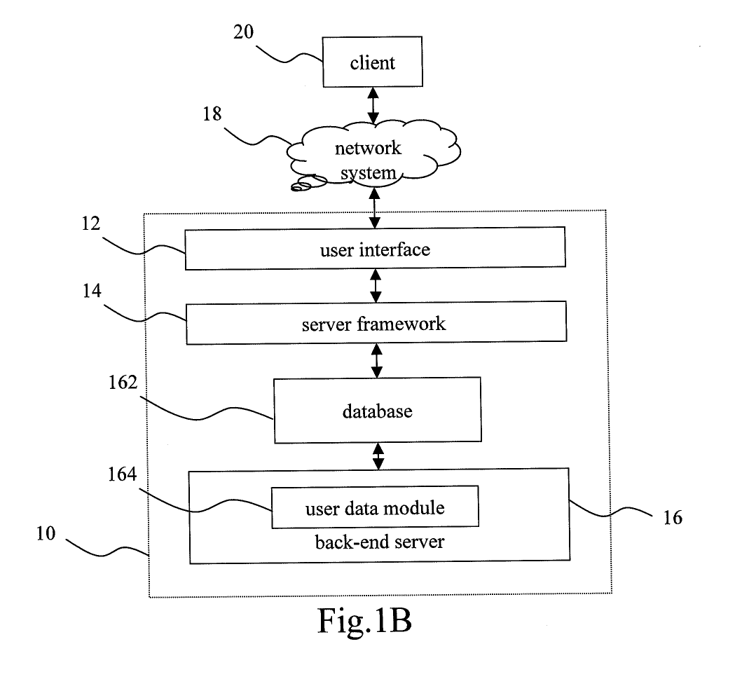

Refer to FIG. 1A a block diagram schematically showing a cloud-based multimedia teaching system 10 according to a first embodiment of the present invention. The cloud-based multimedia teaching system 10 comprises a user interface 12, at least one back-end server 16, and a server framework 14 interconnecting the user interface 12 and the back-end server 16. In the present invention, the server framework 14 is realized with the Adobe ColdFusion, which is a program framework operating in the back-end server 16 to provide service for clients and retrieve data from the back-end server. The back-end server 16 is a three-in-one device including a database 162 and a user data module 164 for storing data of a plurality of courses and data of a plurality of users. The data of users includes names or codes of users, registering information, staying time of each webpage, pause time between two adjacent clicks, records of learning achievements, etc. The data of courses is in form of text, video, power point files, pictures or animations, which are all in the Adobe Flash format. If data of courses is in form of text, it is directly stored in the database 162. Data in other forms are stored in the back-end server 16. The links to the addresses where the data is located in the back-end server 16 are stored in the database 162. The data of users is stored in the user data module 164. A client 20 is linked to the user interface 12 of the cloud-based multimedia teaching system 10 to operate the system via a network system 18, such as the Internet or a telecommunication network.

Refer to FIG. 1B a block diagram schematically showing a cloud-based multimedia teaching system 10 according to a second embodiment of the present invention. In the second embodiment, the database 162 is not built in the back-end server 16 but independent from the back-end server 16. The server framework 14 transmits data of courses to the database 162, and the database 162 determines whether to directly store the data of courses in the database 162 or further transmit the data of courses to the back-end server 16. If the data of courses is stored in the back-end server 16, the database 162 records the links to the addresses where the data is located.

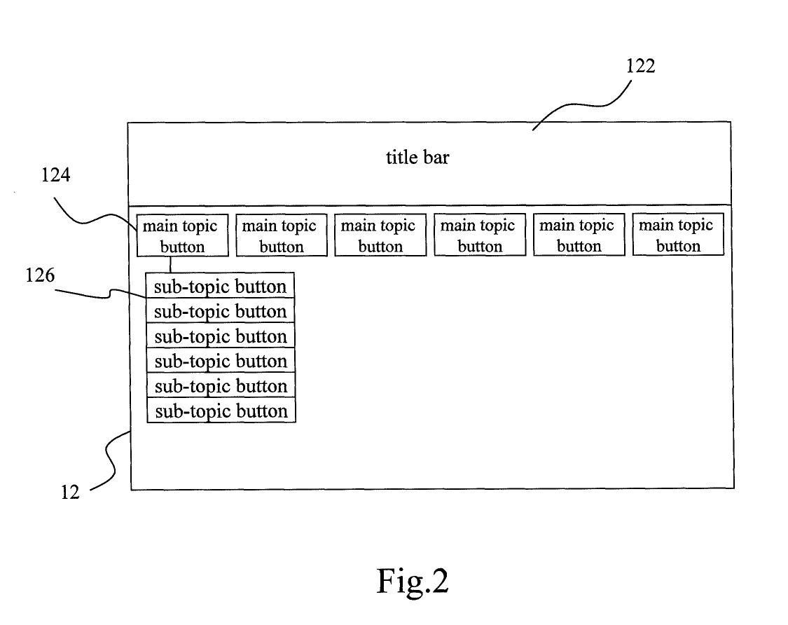

The user interface 12 contains a plurality of buttons respectively denoting different courses. Refer to FIG. 2 for an embodiment of the user interface 12, wherein there is a title bar 122 presented on the user interface 12. A plurality of main topic buttons 124 is presented below the title bar 122. Each subject button 124 further contains a plurality of sub-topic buttons 126. There are many layouts for the user interface 12. A preferred layout of the user interface 12 has six main topic buttons 124, and each subject button 124 has twelve sub-topic buttons 126. The courses presented on the user interface 12 are all in the Abode Flash format.

In the present invention, the server framework 14 interconnects the client 20 and the back-end server 16, uses the Flash Remoting technology to intercourse with the back-end server 16, and retrieves data from the back-end server 16.

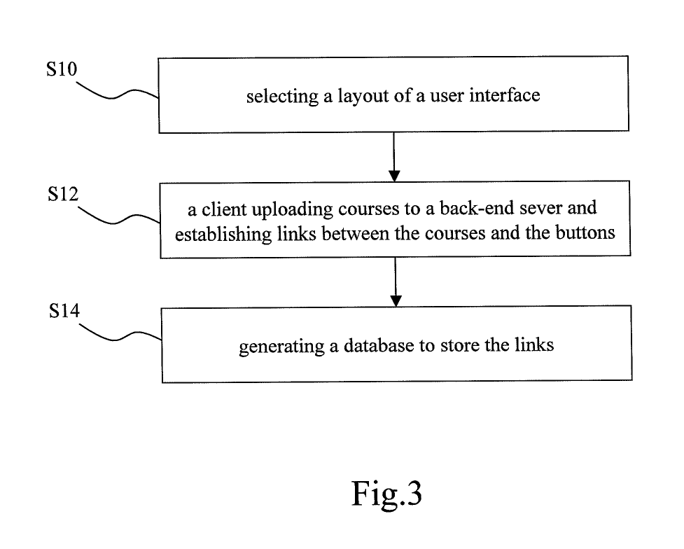

Refer to FIG. 3 a flowchart of a development method for a cloud-based multimedia teaching system according to a third embodiment of the present invention. In Step S10, select a layout of a user interface, including determining size of the webpage, number of the main topic buttons, and number of the sub-topic buttons. In Step S12, a client uploads data of courses to a back-end sever via a server framework in the Flash Remoting technology; after the data of courses is stored in the back-end server, establish links between the addresses where the data of courses is stored and the subject/sub-topic buttons of the user interface. In Step S14, generate a database to store the links. The database is built in the back-end server or independent from the back-end server. When a client clicks on the button, the cloud-based multimedia teaching system retrieves a course according to the corresponding link stored in the database and then presents the course on the user interface.

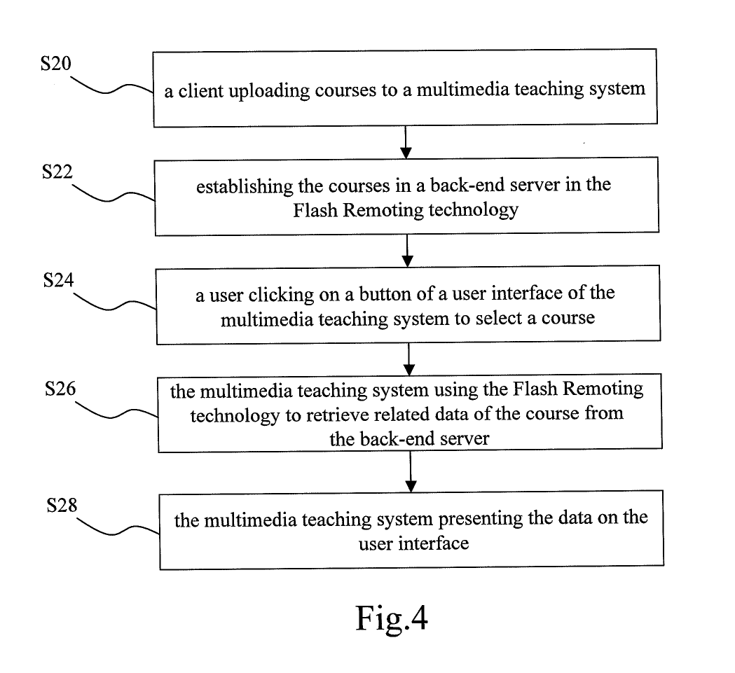

Refer to FIG. 4 a flowchart of an interaction method for a cloud-based multimedia teaching system according to a fourth embodiment of the present invention. In Step S20, a client uploads data of at least one course to the cloud-based multimedia teaching system. In Step S22, the cloud-based multimedia teaching system intercourses with a back-end server via a server framework in the Flash Remoting technology and transmits the data of courses to the back-end server. If the data of courses is in form of text files, the data is directly stored in a database. If the data is in form of image files or an AV files, it is stored in the back-end server. Further, the links to the addresses where the non-text files are located are stored in the database. The data of courses established in the back-end server are all converted to have the Abode Flash format. In Step S24, a user clicks on the buttons of a user interface of the multimedia teaching system to select a course. For example, the user presses a subject button and then presses a sub-subject button. In Step S26, the cloud-based multimedia teaching system uses the Flash Remoting technology to retrieve related data of the selected course from the back-end server via the server framework. In Step S28, the cloud-based multimedia teaching system presents the retrieved data on the user interface thereof.

A user has to register in the user interface of the cloud-based multimedia teaching system and enter the information thereof beforehand. After that, the operational details of the user are recorded in the user data module, including the login time, the staying time of each webpage, the pause time between two adjacent clicks, the compulsory logout, the progress of the course, the achievement of learning, etc., whereby the teacher and the user can review the status of learning. Further, the user needn't study a course in the sequence of Lesson 1, Lesson 2, . . . but can click on the button to directly select an arbitrary lesson. Thereby, the user can flexibly modify the contents and progress of the course to meet his requirement.

The teacher can easily edit the lessons via merely selecting the layouts of the webpages and uploading the lessons, neither needing knowledge/experience of program languages nor downloading/uploading the whole multimedia teaching system. After having edited the lessons, the teacher uploads merely the data of the lessons to the back-end server. Then, the system automatically generates the links to the addresses where the data is located and stores the links in the database. Therefore, the teacher can use an arbitrary computer to edit or revise lessons anytime.

In conclusion, the present invention discloses a cloud-based multimedia teaching system, a development method and an interaction method thereof. The cloud-based multimedia teaching system is an online teaching system, wherein the teacher can easily edit or revise lessons in an arbitrary client computer anytime and then uploads the lessons to the cloud-based multimedia teaching system. In the present invention, the lessons presented on the user interface are all in the Abode Flash format, and the client intercommunicates with the back-end server in the Flash Remoting technology. Therefore, lessons can be diversified with movies and animations to interest learners. In the present invention, the lessons are not in form of streaming AV files. Therefore, the user can select an arbitrary lesson to learn or repeat studying the same lesson. In the present invention, all the operations of a user are recorded in the back-end server, including the lessons the user has studied, the time the user has spent on a lesson, and the evaluation of the user's achievement. Thereby, the status of learning can be monitored more effectively, and the learner and teacher can evaluate and modify the progress of learning according to the records.

The embodiments described above are only to exemplify the present invention but not to limit the scope of the present invention. Any equivalent modification or variation according to the characteristic or spirit of the present invention is to be also included within the scope of the present invention.

What is claimed is:

1. An interaction method for a cloud-based multimedia teaching system, comprising steps:
a client uploading at least one course to a multimedia teaching system via the cloud;
said multimedia teaching system communicating with a back-end server via a server framework in a Flash Remoting technology to establish said course in said back-end server; and
a user clicking on a button of a user interface of said multimedia teaching system to access related data of said course via said server framework in said Flash Remoting technology and present said related data on said user interface of said multimedia teaching system.

2. The interaction method for a cloud-based multimedia teaching system according to claim 1, wherein said server framework is realized with an Adobe ColdFusion technology.

3. The interaction method for a cloud-based multimedia teaching system according to claim 1, wherein said back-end server includes at least one database, and wherein if said courses are in form of text files, said courses are directly stored in said database, and wherein if said courses are in form of non-text files, said courses are stored in said back-end server, and wherein links to addresses where said courses are located are stored in said database.

4. The interaction method for a cloud-based multimedia teaching system according to claim 1, further comprises at least one database, and wherein if said courses are in form of text files, said courses are directly stored in said database, and wherein if said courses are in form of non-text files, said courses are transmitted to said back-end server, and wherein links to addresses where said courses are located are stored in said database.

5. The interaction method for a cloud-based multimedia teaching system according to claim 1, wherein said course is in form of text, video, a PowerPoint file, pictures, or animation.

6. The interaction method for a cloud-based multimedia teaching system according to claim 1, wherein said courses established in said back-end server are in an Adobe Flash format.

7. The interaction method for a cloud-based multimedia teaching system according to claim 1, wherein courses selected by users are recorded in said back-end server.

8. A development method for a cloud-based multimedia teaching system, comprising steps:
selecting a layout for a user interface containing a plurality of buttons;
a client uploading at least one course to a back-end server, and establishing a plurality of links between said courses and said buttons; and
generating a database to store said links.

9. The development method for a cloud-based multimedia teaching system according to claim 8, wherein said courses are established in said back-end server via a server framework in a Flash Remoting technology.

10. The development method for a cloud-based multimedia teaching system according to claim 8, wherein if said courses are in form of text files, said courses are directly stored in said database.

11. The development method for a cloud-based multimedia teaching system according to claim 9, wherein said server framework is realized with an Adobe ColdFusion technology.

12. A cloud-based multimedia teaching system comprising
a user interface containing a plurality of buttons respectively denoting a plurality of courses;
at least one back-end server storing data of a plurality of courses and a plurality of pieces of user data;
a database storing links between said buttons and said courses; and
a server framework connecting with a client and said database, intercommunicating with said back-end server in a Flash Remoting technology, and retrieving data from said back-end server.

13. The cloud-based multimedia teaching system according to claim 12, wherein said back-end server further comprises a user data module storing said user data.

14. The cloud-based multimedia teaching system according to claim 13, wherein said user data includes names or codes of users, registering information, staying time of each webpage, pause time between two adjacent clicks, and records of learning achievements.

15. The cloud-based multimedia teaching system according to claim 12, wherein said buttons include a plurality of main topic buttons and a plurality of sub-topic buttons below each said subject button.

16. The cloud-based multimedia teaching system according to claim 12, wherein said server framework is realized with an Adobe ColdFusion technology.

17. The cloud-based multimedia teaching system according to claim 12, wherein said database is built in said back-end server or independent from said back-end server.

18. The cloud-based multimedia teaching system according to claim 12, wherein if said courses are in form of text files, said courses are directly stored in said database, and wherein if said courses are in form of non-text files, said courses are transmitted to said back-end server, and wherein links to addresses where said courses are located are stored in said database.

19. The cloud-based multimedia teaching system according to claim 17, wherein if said courses are in form of text files, said courses are directly stored in said database, and wherein if said courses are in form of non-text files, said courses are transmitted to said back-end server, and wherein links to addresses where said courses are located are stored in said database.

20. The cloud-based multimedia teaching system according to claim 12, wherein said courses established in said back-end server are in an Adobe Flash format.
